(19) United States
(12) Patent Application Publication
(10) Pub. No.: US 2006/0267732 A1
(43) Pub. Date: Nov. 30, 2006

(54) System and method for reading RFID tags

(75) Inventor: Zing-Wei Kang, Taipei (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/441,248

(22) Filed: May 26, 2006

(30) Foreign Application Priority Data
May 31, 2005 (TW) 094117763

(51) Int. Cl. H04Q 5/22

(52) U.S. Cl. 340/10.1; 340/572.1

(57) ABSTRACT

A system and a method for reading a large number of RFID tags at the same time. The system comprises: a magnetic field provider for providing a reading space so as to accommodate the plurality of RFID tags, the magnetic field provider further comprising a plurality of magnetic field units and a loader for loading the plurality of magnetic field units disposed around the reading space to provide the reading space with a magnetic field; and a reader for receiving a signal when a least one of the plurality of RFID tags transmits the signal induced by the magnetic field. The method comprises steps of: providing a reading space so as to accommodate the plurality of RFID tags; providing the reading space with a plurality of magnetic fields; and reading a signal when a least one of the plurality of RFID tags transmits the signal induced by the plurality of magnetic fields.

### BACKGROUND OF THE INVENTION

1. Field of the Invention

The present invention generally relates to a system and a method for reading wireless tags and, more particularly, to a system and a method for reading a large number of RFID (radio frequency identification) tags at the same time.

2. Description of the Prior Art

In recent years, RFID has attracted much attention for its applications in national security, logistics, inventory and supply chain management of a warehouse or supermarket.

Please refer to FIG. 1, which is a basic structure of an RFID system. The RFID system comprises a reader 1, a tag (usually referred to as a transponder) 2 and an application system 3. The reader 1 transmits RF energy that generates a magnetic field. The transponder 2, while moving, obtains the energy from the magnetic field according to Faraday's Law and, therefore, the ID code is transmitted from the transponder 2 to the reader 1, which then decodes and ID code and communicates with the application system 3.

The transponder 2 generally comprises: an antenna 21 for communicating with the reader 1; a rectification device 22 for converting the AC voltage induced by the antenna 21 into the DC voltage so as to provide stable power through a regulator (not shown); a demodulation circuit 23 for removing the carrier so as to obtain modulated signals; a microprocessor 24 for decoding the signal from the reader 1 and returning data to the reader 1, wherein the data is encrypted/decrypted if necessary; a memory 25 for storing ID data; a modulation circuit 26 for modulating the signal from the microprocessor 24 and returning to the reader 1 through the antenna 21.

Te reader 1 comprises: an antenna 11 for transmitting a signal to the transponder 2 and receiving the data from the transponder 2; a transceiving unit 12; a modulation circuit 13 for transmitting the signal to be received by the transponder 2 to the transceiving unit 12; a microprocessor 14 for transmitting the signal to be received by the transponder 2 to the modulation circuit 13, and meanwhile decoding the signal from the transponder 2 and returning data to the application system 3, wherein the data is encrypted/decrypted if necessary; a memory 15 for storing ID data; a demodulation circuit 26 for demodulating the signal from transponder 2 into a digital signal and returning to the microprocessor 14.

The application system 3 receives what the reader 1 transmits and reacts in response to the reader 1 so as to control operations such as deployment, etc.

The RFID system uses a non-contact technique without a conventional magnetic strip or bar code scanned by a reader. When the data stored in the RFID tag is sensed, the system performs automatic identification, verification, etc. Thus, applications of the RFID system have become more flexible and wider.

However, the currently used RFID system is only peer-to-peer and not convenient for detecting a large number of tags. Therefore, there is need in providing a system and a method for reading a plurailty of tags at the same time.

### SUMMARY OF THE INVENTION

It is a primary object of the present invention to provide a system and a method for reading a plurality of wireless tags at the same time.

In order to achieve the foregoing object, the present invention provides a system for reading a plurality of RFID tags, the system comprising:

a magnetic field provider for providing a reading space so as to accommodate the plurality of RFID tags, the magnetic field provider further comprising a plurality of magnetic field units and a loader for loading the plurality of magnetic field units disposed around the reading space to provide the reading space with a magnetic field; and

a reader for receiving a signal when a least one of the plurality of RFID tags transmits the signal induced by the magnetic field.

The present invention further provides a method for reading a plurality of RFID tags, the method comprising steps of:

providing a reading space so as to accommodate the plurality of RFID tags;

providing the reading space with a plurality of magnetic fields; and

reading a signal when a least one of the plurality of RFID tags transmits the signal induced by the plurality of magnetic fields.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a basic structure of an RFID system;

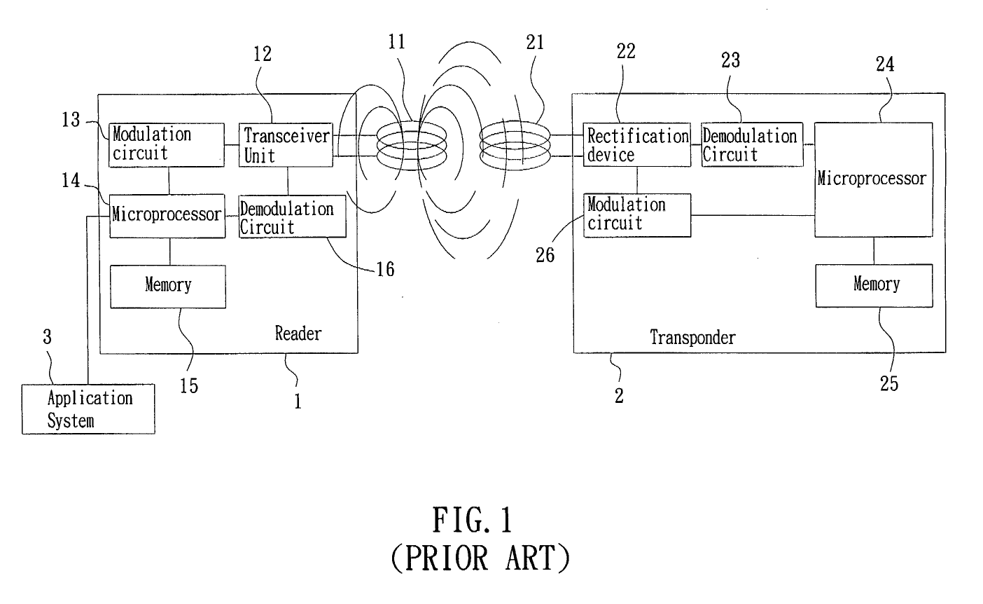

FIG. 2A to FIG. 2C illustrate the concept of rotational magnetic fields;

FIG. 3 is a schematic diagram showing a system for reading RFID tags according to the present invention; and

FIG. 4 is a flow chart describing a method for reading RFID tags according to the present invention.

### DETAILED DESCRIPTION OF THE PREFERRED EMBODIMENT

The present invention providing a system and a method for reading RFID (radio frequency identification) tags can be exemplified by the preferred embodiment as described hereinafter.

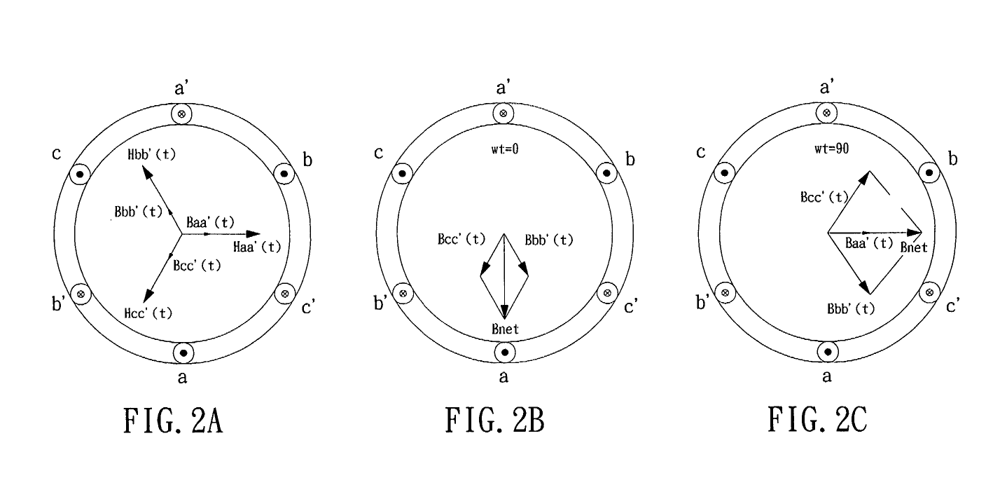

Please refer to 2A to FIG. 2C, which illustrate the concept of rotational magnetic fields. In one embodiment of the present invention, a three-phase current (as a function of time) enters a three-phase coil (as a function of space) in a reader, and the three-phase current is expressed as:
i_{aa′}=Iₘ sin wt
i_{bb′}=I_{M} sin(wt−120°)
i_{cc′}=I_{M} sin(wt−240°)

According to Ampere's Right-Hand Grip Rule, a thee-phase magnetic field is generated and expressed as:
H_{aa′}(t)=H_{M} sin(wt)∠0°
H_{bb′}=H_{M} sin(wt−120°)∠120°
H_{cc′}=H_{M} sin(wt−240°)∠240°

where sin wt is time-dependent and ∠ describes the phase difference (space-dependent).

Since the magnetic flux density B is equal to H/μ, therefore B is expressed as:
B_{aa′}(t)=(H_{M}/μ)sin wt∠0°
B_{bb′}=(H_{M}/μ)sin(wt−120°)∠120°
B_{cc′}=(H_{M}/μ)sin(wt−240°)∠240°

Accordingly, the total magnetic flux density Bₙₑₜ(t) at any time is expressed as:

$$\begin{matrix}{B}_{net} ( t ) = {B}_{{aa}^{′}} ( t ) + {B}_{{bb}^{′}} ( t ) + {B}_{{cc}^{′}} ( t ) \\ = {B}_{M} sin ( wt ) i - 0.5 {B}_{M} sin ( wt - 120 ) i + \frac{\sqrt{3}}{2} {B}_{M} sin ( wt - 120 ) j - \\ 0.5 {B}_{M} sin ( wt - 240 ) i - \frac{\sqrt{3}}{2} {B}_{M} sin ( wt - 240 ) j \\ = {B}_{M} sin ( wt ) i - 0.5 {B}_{M} sin ( wt - 120 ) i + \frac{\sqrt{3}}{2} {B}_{M} sin ( wt - 120 ) j - \\ 0.5 {B}_{M} sin ( wt - 240 ) i - \frac{\sqrt{3}}{2} {B}_{M} sin ( wt - 240 ) j \\ = ( {B}_{M} sin ( wt ) - \frac{1}{4} {B}_{M} sin ( wt ) + \frac{\sqrt{3}}{4} {B}_{M} cos ( wt ) + \frac{1}{4} {B}_{M} sin ( wt ) - \frac{\sqrt{3}}{4} {B}_{M} cos ( wt ) ) i + \\ ( - \frac{\sqrt{3}}{4} {B}_{M} sin ( wt ) - \frac{3}{4} {B}_{M} cos ( wt ) + \frac{\sqrt{3}}{4} {B}_{M} sin ( wt ) - \frac{3}{4} {B}_{M} cos ( wt ) ) j\end{matrix}$$

$${B}_{net} ( t ) = 1.5 {B}_{M} \times ( i sin wt + j cos wt ) \\$$

The net magnetic flux density Bₙₑₜ(t)=1.5B_{M}j when wt=0, which is described in FIG. 2B and Bₙₑₜ(t)=1.5B_{M}i when wt=90, which is described in FIG. 2C.

Therefore, a rotational magnetic field is generated according to Faraday's Law.

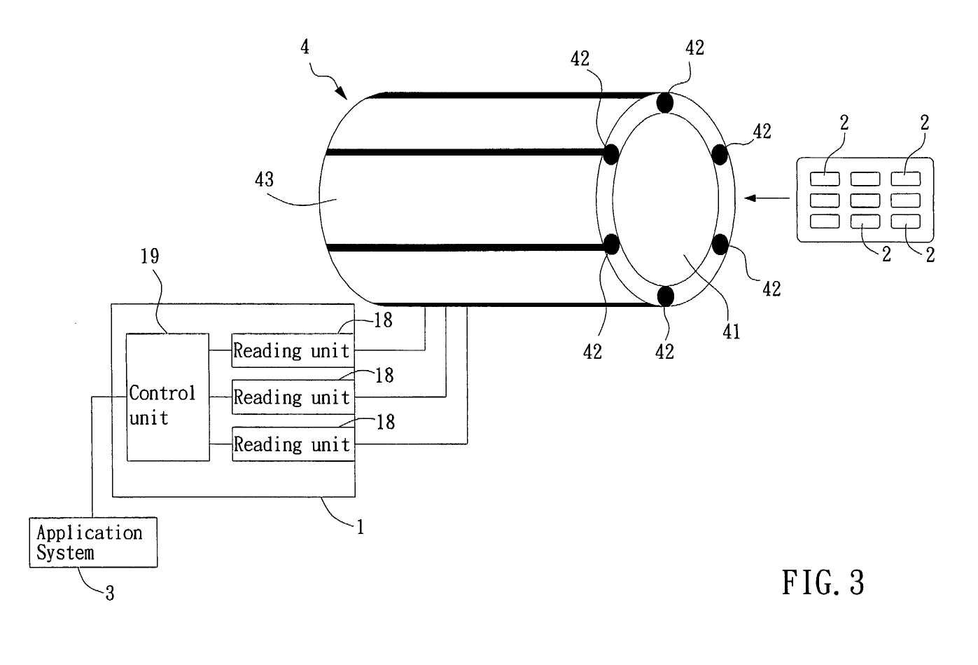

Please refer to FIG. 3, which is a schematic diagram showing a system for reading plurality of RFID tags according to the present invention. In FIG. 3, the system comprises: a magnetic field provider 4 and a reader 1. The magnetic field provider 4 provides a reading space 41 so as to accommodate the plurality of RFID tags 2. The magnetic field provider 4 further comprises a plurality of magnetic field units 42 and a loader 43 for loading the plurality of magnetic field units 42 disposed around the reading space 41 to provide the reading space 41 with a magnetic field.

In the preferred embodiment of the present invention, a three-phase current source (with a phase difference of 120 degrees between two of three phases) is used so as to supply the magnetic field units. The magnetic field units are three magnetic field units and each comprises two windings symmetrically disposed apart by 60 degrees around the loader, which is a tube-shaped object enclosing the reading space therein, as shown in FIGS. 2A to 2C. The three magnetic field units are long straight wires. Alternatively, the tube-shaped object has a central axis around which the loader rotates at an angular velocity that is adjustable.

The reader 1 receives a signal when a least one of the plurality of RFID tags 2 transmits the signal induced by the magnetic field in the reading space 41. In the preferred embodiment of the present invention, the reader 1 comprises a plurality of reading units 18, each coupled to one of the plurality of magnetic field units 42 so as to receive the signal from the RFID tag 2. Moreover, the RFID system further comprises a control unit 19 for selecting a strongest one of received signals by the plurality of reading units as the signal to be transmitted to the application system 3.

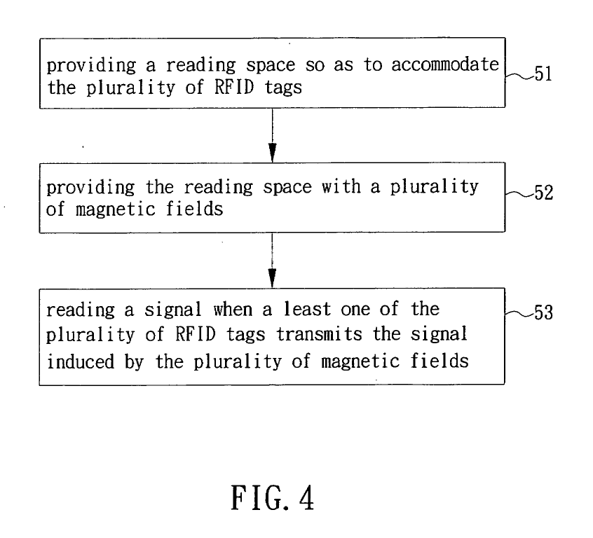

FIG. 4 is a flow chart describing a method for reading RFID tags according to the present invention. The method comprises steps of:

Step 51: providing a reading space so as to accommodate the plurality of RFID tags. The reading space is a tube-shaped object.

Step 52: providing the reading space with a plurality of magnetic fields. The plurality of magnetic fields are generated by a plurality of magnetic field units disposed around the reading space. A three-phase current source is used so as to supply the plurality of magnetic field units.

Step 53: reading a signal when a least one of the plurality of RFID tags transmits the signal induced by the plurality of magnetic fields. In the preferred embodiment, a plurality of receivers are provided for receiving the signal respectively so as to select a strongest one of received signals as the signal to be transmitted to the application system 3.

According to the above discussion, it is apparent that the present invention discloses a method for connecting a handset to a Bluetooth hands-free unit when the handset is to make or receive a phone call while being disconnected from the Bluetooth hands-free unit such that the driver can drive safely in a vehicle. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A system for reading a plurality of wireless tags, said system comprising:
a magnetic field provider for providing a reading space so as to accommodate said plurality of wireless tags, said magnetic field provider further comprising a plurality of magnetic field units and a loader for loading said plurality of magnetic field units disposed around said reading space to provide said reading space with a plurality of magnetic fields; and
a reader for receiving a signal when a least one of said plurality of wireless tags transmits said signal induced by said plurality of magnetic fields.

2. The system as recited in claim 1, wherein said loader is a tube-shaped object enclosing said reading space therein.

3. The system as recited in claim 2, wherein said plurality of magnetic field units are disposed uniformly around said tube-shaped object.

4. The system as recited in claim 3, wherein said plurality of magnetic field units are three magnetic field units.

5. The system as recited in claim 4, wherein each of said magnetic field units comprises two windings symmetrically disposed apart by 60 degrees around said tube-shaped object.

6. The system as recited in claim 4, wherein a three-phase current source is used so as to supply said three magnetic field units.

7. The system as recited in claim 6, wherein said three-phase current source has a phase difference of 120 degrees between two of three phases.

8. The system as recited in claim 4, wherein said reader comprises three reading units, each coupled to one of said three magnetic field units so as to receive said signal.

9. The system as recited in claim 8, further comprising a control unit for selecting a strongest one of received signals by said three reading units as said signal.

10. The system as recited in claim 2, wherein said tube-shaped object has a central axis around which said loader rotates.

11. The system as recited in claim 1, wherein said three magnetic field units are long straight wires.

12. The system as recited in claim 1, wherein said loader rotates at an adjustable angular velocity.

13. A method for reading a plurality of wireless tags, said method comprising steps of:
providing a reading space to accommodate said plurality of wireless tags;
providing said reading space with a plurality of magnetic fields; and
reading a signal when a least one of said plurality of wireless tags transmits said signal induced by said plurality of magnetic fields.

14. The method as recited in claim 13, wherein said reading space is enclosed by a tube-shaped object.

15. The method as recited in claim 14, further comprising a step of:
providing a plurality of magnetic field units disposed around said reading space to provide said reading space with said plurality of magnetic fields.

16. The method as recited in claim 15, further comprising a step of:
providing a three-phase current source so as to supply said plurality of magnetic field units.

17. The method as recited in claim 16, wherein said three-phase current source has a phase difference of 120 degrees between two of three phases.

18. The method as recited in claim 14, wherein said tube-shaped object has a central axis around which said plurality of magnetic fields rotate.

19. The method as recited in claim 13, further comprising a step of:
providing a plurality of receivers for receiving said signal respectively.

20. The method as recited in claim 19, further comprising a step of:
selecting a strongest one of received signals by said plurality of receivers.
